(19) United States
(12) Patent Application Publication
(10) Pub. No.: US 2025/0203532 A1
(43) Pub. Date: Jun. 19, 2025

(54) DETAILS OF PHR REPORTING FOR SIMULTANEOUS TRANSMISSION

(71) Applicant: QUALCOMM Incorporated, San Diego, CA (US)

(72) Inventors: Mostafa KHOSHNEVISAN, San Diego, CA (US); Yitao CHEN, San Marcos, CA (US); Yan ZHOU, San Diego, CA (US); Fang YUAN, Beijing (CN); Tao LUO, San Diego, CA (US); Xiaoxia ZHANG, San Diego, CA (US); Jing SUN, San Diego, CA (US)

(21) Appl. No.: 18/851,670

(22) PCT Filed: Jun. 1, 2022
(86) PCT No.: PCT/CN2022/096518

§ 371 Date: Sep. 26, 2024

(51) Int. Cl. H04W 52/36; H04B 7/06; H04L 5/00; H04W 56/00

(52) U.S. Cl. CPC H04W 52/365; H04B 7/0626; H04L 5/001; H04W 56/0015

(57) ABSTRACT

Method and apparatus for reporting of a PHR for simultaneous transmission. The apparatus receives a configuration comprising a first resource pool and a second resource pool, each of the first resource pool and the second resource pool correspond to at least a respective SRS resource set. The apparatus measures one or more resources within the first resource pool and the second resource pool. The apparatus transmits a PHR comprising at least one SSBRI or CRI associated with the first resource pool or at least one SSBRI or CRI associated with the second resource pool.

### TECHNICAL FIELD

The present disclosure relates generally to communication systems, and more particularly, to a configuration for the reporting of a power headroom report (PHR) for simultaneous transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives a configuration comprising a first resource pool and a second resource pool, each of the first resource pool and the second resource pool correspond to at least a respective sounding reference signal (SRS) resource set. The apparatus measures one or more resources within the first resource pool and the second resource pool. The apparatus transmitting a power headroom report (PHR) comprises at least one synchronization signal block (SSB) resource indicator (SSBRI) or channel state indicator reference signal (CSI-RS) resource indicator (CRI) associated with the first resource pool or at least one SSBRI or CRI associated with the second resource pool.

In an aspect of the disclosure, a method, a computer-readable medium, and an apparatus are provided. The apparatus may be a device at a UE. The device may be a processor and/or a modem at a UE or the UE itself. The apparatus receives a configuration comprising a first resource pool and a second resource pool, the configuration configuring the UE with separate or joint PHR triggering and reporting. The apparatus measures one or more resources within the first resource pool and the second resource pool. The apparatus transmits a power headroom report (PHR) associated with the first resource pool or the second resource pool separately or jointly based on the configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a PHR MAC-CE.

FIG. 5 is a diagram illustrating an example of a single DCI based TDM PUSCH.

FIG. 6 is a diagram illustrating an example of a PHR MAC-CE.

FIG. 7 is a diagram illustrating an example of a single DCI based SDM PUSCH.

FIG. 8 is a diagram illustrating an example of a single DCI based FDM PUSCH.

FIG. 9 is a diagram illustrating an example of time domain overlapping PUSCHs.

FIG. 10 is a diagram illustrating an example of an enhanced MPE MAC-CE.

FIG. 11 is a diagram illustrating an example of an enhanced MPE report.

FIG. 12 is a diagram illustrating an example of a UE configured with two separate resource pools.

FIG. 13 is a diagram illustrating an example of a UE configured with two separate resource pools.

FIG. 14 is a call flow diagram of signaling between a UE and a network entity.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

### DETAILED DESCRIPTION

In wireless communications, a UE may transmit a PHR for uplink carrier aggregation. A PHR may be triggered by a MAC layer and may be based on one or more of a set of timers (e.g., phr-PeriodicTimer, phr-ProhibitTimer), a power change greater than a configurable threshold for path loss reference signal (PL RS) used for power control in any uplink component carrier (CC), an activation of a secondary cell (SCell), or an active bandwidth part of a configured CC is changed from dormant to non-dormant. When triggered, PHR may be reported in a PHR MAC-CE on a first available PUSCH that corresponds to an initial transmission of a TB that can accommodate the MAC-CE.

Aspects presented herein provide a configuration for the reporting of PHR for simultaneous transmission. The aspects presented herein may allow a UE to report a PHR associated with a first resource pool or a second resource pool.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

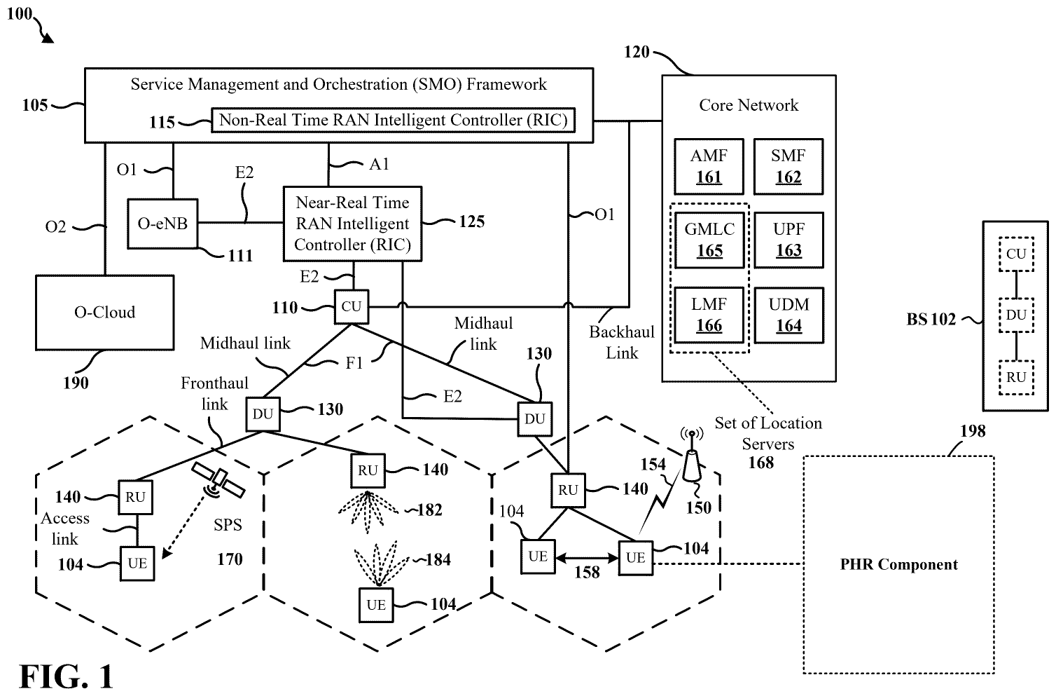

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a PHR component 198 configured to receive a configuration comprising a first resource pool and a second resource pool, each of the first resource pool and the second resource pool correspond to at least a respective SRS resource set; measure one or more resources within the first resource pool and the second resource pool; and transmit a PHR comprises at least one SSBRI or CRI associated with the first resource pool or at least one SSBRI or CRI associated with the second resource pool. In certain aspects, the PHR component 198 may be configured to receive a configuration comprising a first resource pool and a second resource pool, the configuration configuring the UE with separate or joint PHR triggering and reporting; measure one or more resources within the first resource pool and the second resource pool; and transmit a PHR associated with the first resource pool or the second resource pool separately or jointly based on the configuration.

Although the following description may be focused on 5G NR, the concepts described herein may be applicable to other similar areas, such as LTE, LTE-A, CDMA, GSM, and other wireless technologies.

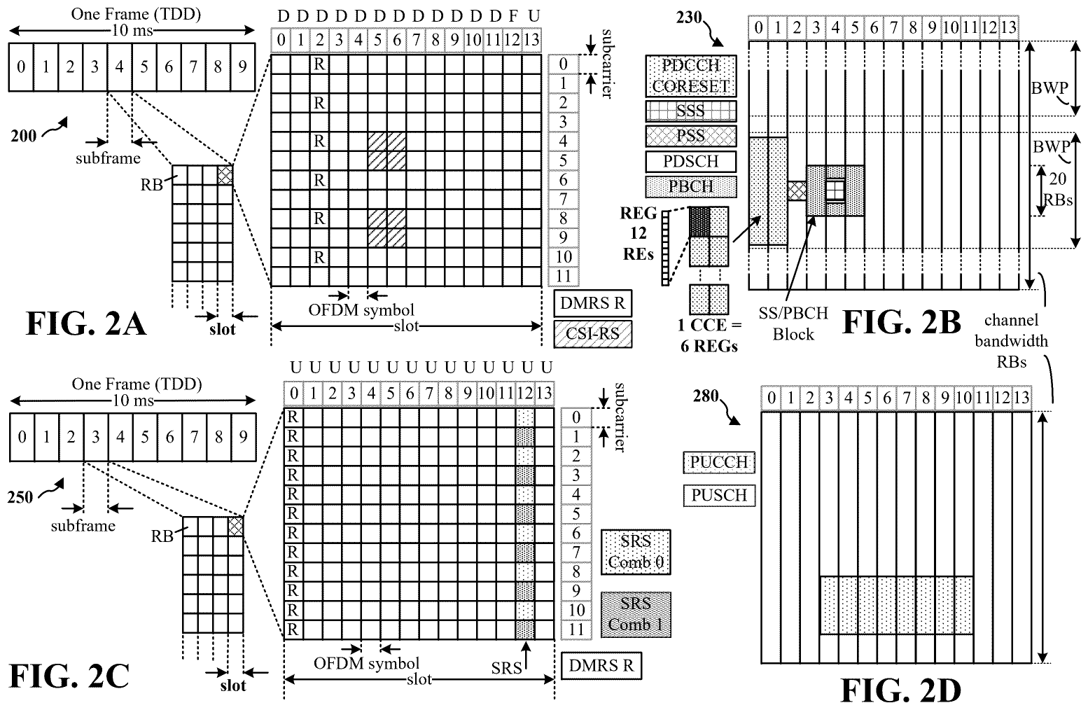

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

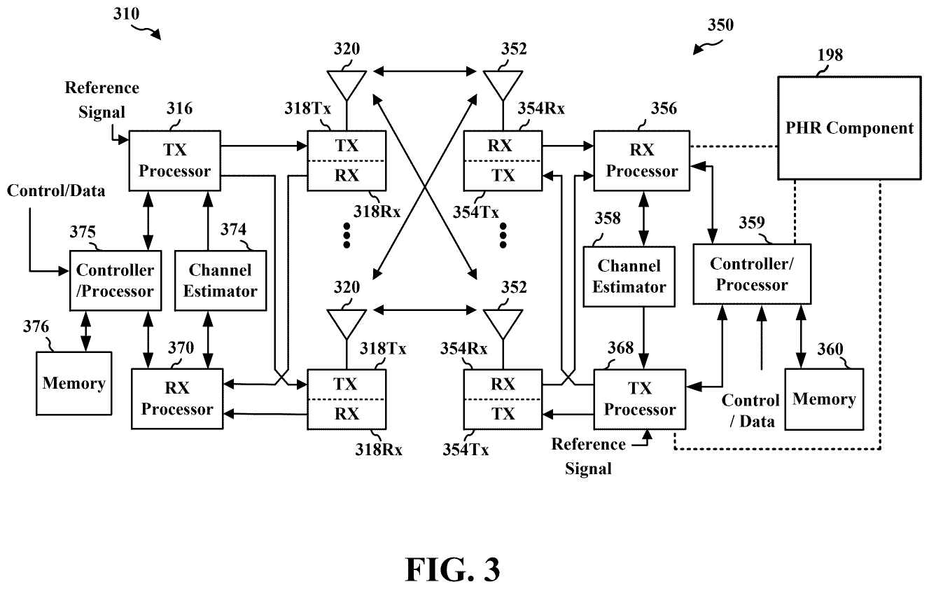

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PHR component 198 of FIG. 1.

In wireless communications, a UE may transmit a PHR for uplink carrier aggregation. A PHR may be triggered by a MAC layer and may be based on one or more of a set of timers (e.g., phr-PeriodicTimer, phr-ProhibitTimer), a power change greater than a configurable threshold for PL RS used for power control in any uplink CC, an activation of a SCell, or an active bandwidth part of a configured CC is changed from dormant to non-dormant. When triggered, PHR may be reported in a PHR MAC-CE on a first available PUSCH that corresponds to an initial transmission of a TB that can accommodate the MAC-CE as a result of logical channel prioritization (LCP). The PUSCH may be dynamic (e.g., scheduled via DCI) or may be based on a configured grant.

In instances where the UE is configured with multiple CCs for PUSCH transmission, the PHR MAC-CE may include a PHR for more than one CC if multiplePHR is enabled in RRC. Otherwise, PHR is reported only for the primary cell (PCell) and a single-entry MAC-CE format is used. In instances where a first PUSCH in a first CC carries a PHR MAC-CE for a second CC, the MAC-CE may include either an actual PHR or a virtual PHR. The virtual PHR may be based on a reference format. The MAC-CE including the actual PHR or the virtual PHR may be based on whether there is a PUSCH transmission on the second CC at the time of PHR reporting (e.g., in the slot of the first PUSCH) or whether the PUSCH transmission on the second CC is scheduled via DCI that satisfies a timeline condition, otherwise the virtual PHR is reported.

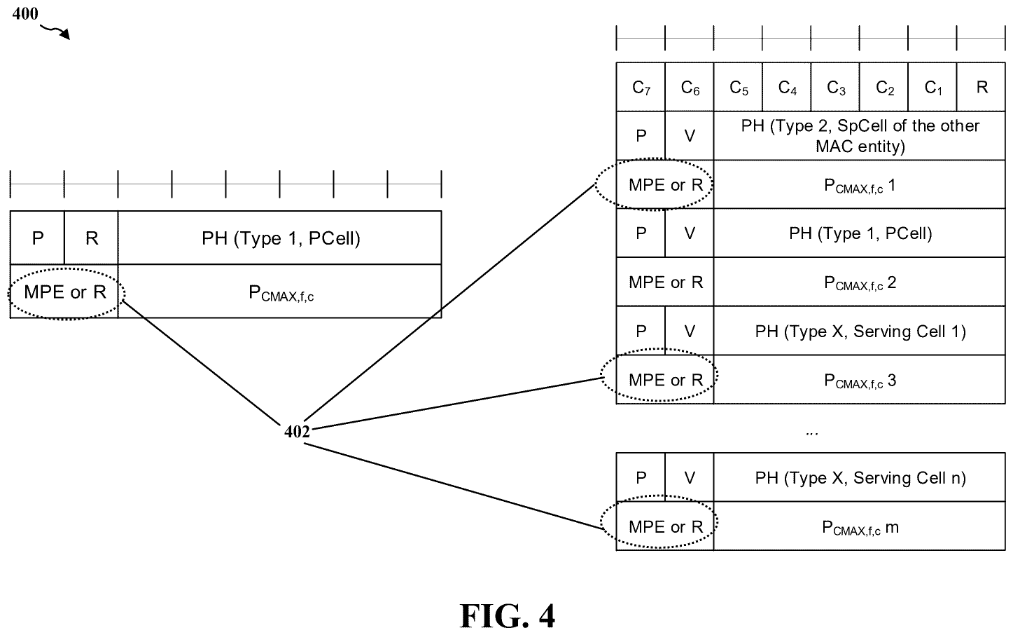

FIG. 4 is a diagram 400 illustrating an example of a PHR MAC-CE. The PHR MAC-CE may comprise a field 402 that indicates an applied power backoff the meet MPE requirements for FR2.

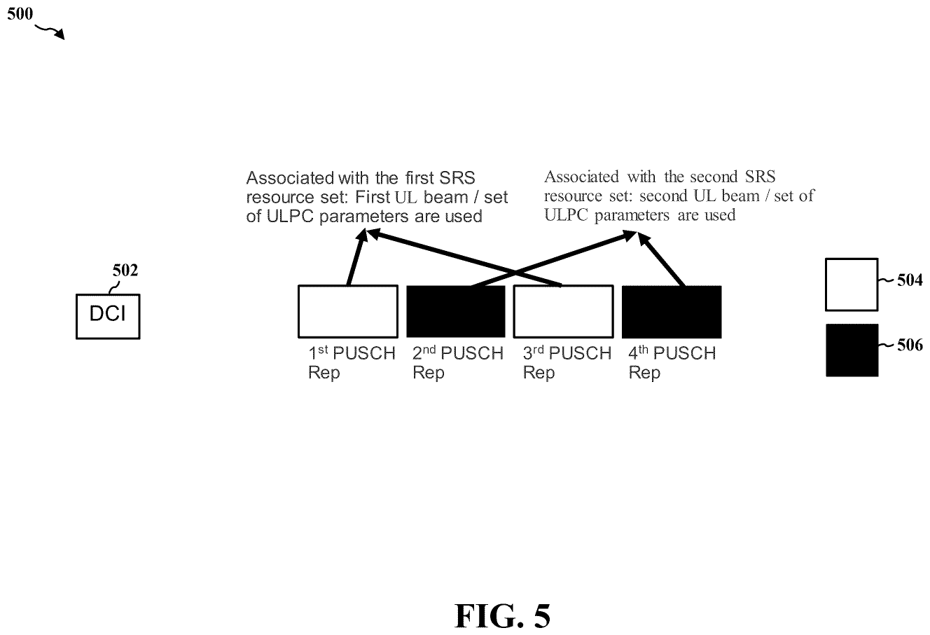

FIG. 5 is a diagram 500 illustrating an example of a single DCI based PUSCH repetition. The single DCI based PUSCH repetition may be time division multiplexed (TDM) and may correspond to different transmission parameters (e.g., beam/spatial relation/TCI state, power control, precoding). PUSCH repetitions scheduled by a single DCI may correspond to two sets of repetitions, where each set has its own beam or power control parameters. In some instances, different repetitions may be associated with the same TB. The two sets of repetitions may correspond to two SRS resource sets, in order to allow for PUSCH repetitions scheduled by a single DCI to correspond to two sets of repetitions. For example, as shown in diagram 500, the DCI 502 may schedule multiple PUSCH repetitions (e.g., 504, 506), where the first set of repetitions 504 use a first beam having a first set of power control parameters, and the second set of repetitions 506 use a second beam having a second set of power control parameters. The first set of repetitions 504 may be targeted towards a first TRP, and the second set of repetitions 506 may be targeted towards a second TRP. The first set of repetitions 504 may be associated with a first SRS resource set having a first uplink beam and set of uplink power control parameters. The second set of repetitions 506 may be associated with a second SRS resource set having a second uplink beam and set of uplink power control parameters. The DCI may indicate two beams or two sets of power control parameters by two corresponding SRI fields for both codebook based and non-codebook based. For codebook based PUSCH, two TPMI fields may indicate two precoders for the two sets of repetitions.

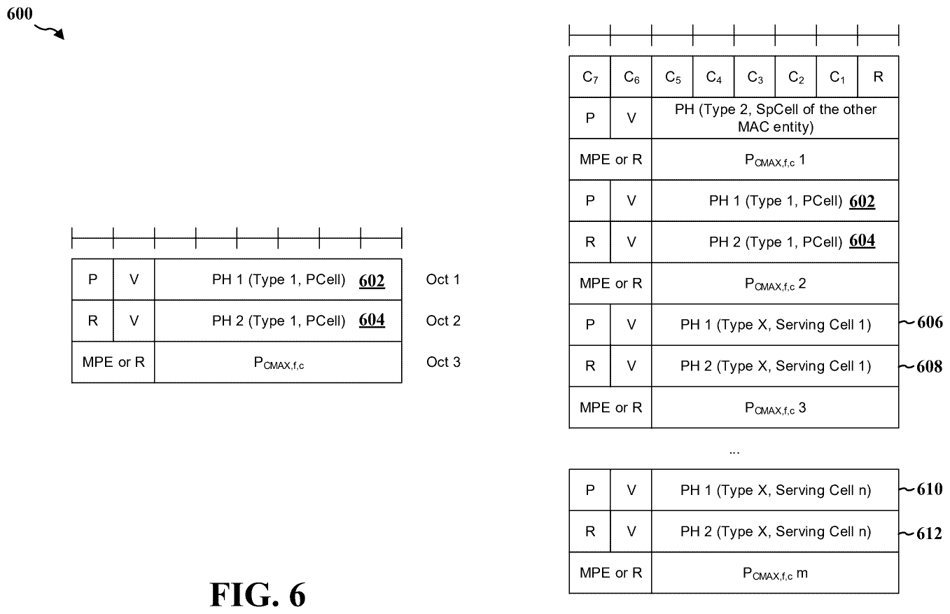

In instances where twoPHRMode is configured (e.g., based on an optional UE capability), for a CC configured with multiple-TRP (mTRP) PUSCH (e.g., configured with two SRS resource sets), two PHR values may be reported in the MAC-CE for the CC, as shown for example in diagram 600 of FIG. 6. Triggering and reporting of PHR may be performed jointly (e.g., not separate per SRS resource set or TRP). One or both of the power headroom (PH) values (e.g., 602, 604) may be real or virtual. Both of the PH values may be real if two PUSCH repetitions associated with different SRS resource sets are transmitted in the same slot and in the slot in which the MAC-CE is reported. In some instances, the MAC-CE may be transmitted in another CC as part of another PUSCH. The diagram 600 of FIG. 6 provides an example of an enhanced single entry PHR for mTRP MAC-CE having two PH values 602, 604, as well as an example of an enhanced multiple entry PHR for mTRP MAC-CE having multiple PH values (e.g., 602, 604, 606, 608, 610, 612).

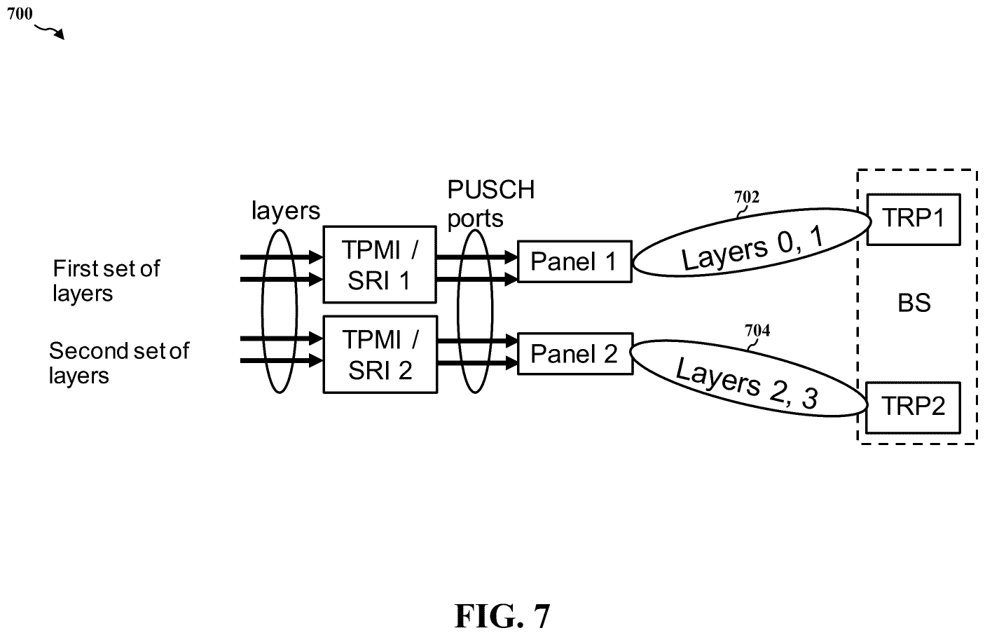

In some instances, such as a single DCI based spatial division multiplex (SDM) PUSCH, a single DCI may schedule a PUSCH with two sets of DMRS ports, layers transmitted from two panels with different transmission beams, precoders, or power control parameters. Two sets of layers (e.g., 702, 704) may be associated with two SRS resource sets, as shown in diagram 700 of FIG. 7. For example, a first layer 702 may be associated with the first SRS resource set having a first transmission beam and a first TCI state. A second layer 704 may be associated with the first SRS resource set having a second transmission beam and a second TCI state. The DCI may include an SRS resource set indicator field, two SRI fields, and two transmit precoder matrix index (TPMI) fields.

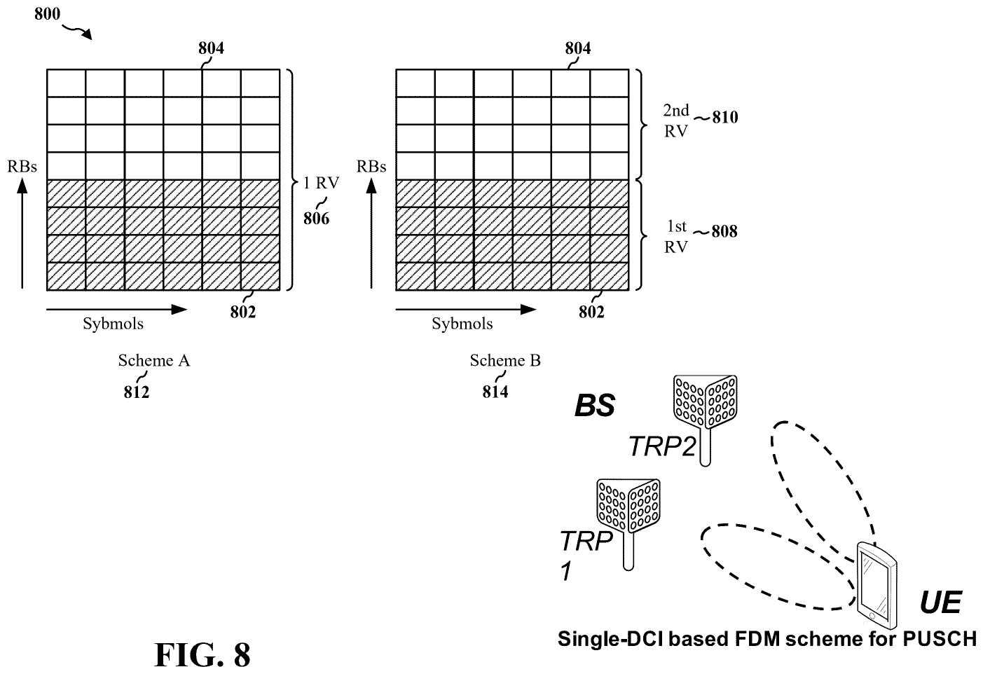

In some instances, such as in single DCI based frequency domain multiplex (FDM) PUSCH, a single DCI may schedule a PUSCH with two sets of RBs transmitted from two panels with different transmit beams, precoders, or power control parameters. Two sets of RBs (e.g., 802, 804) may be associated with 2 SRS resource sets, as shown in diagram 800 of FIG. 8. For example, a first set of RBs 802 may be associated with a first SRS resource set, and a second set of RBs 804 may be associated with a second SRS resource set. Scheme A 812 may comprise a single redundancy value (RV) 806 which may be configured as joint rate matching. Scheme B 814 may comprise two RVs, a first RV 808 and a second RV 810, which may be configured as repetition or separate rate matching. A DCI may include an SRS resource set indicator field, two SRI fields, or two TPMI fields.

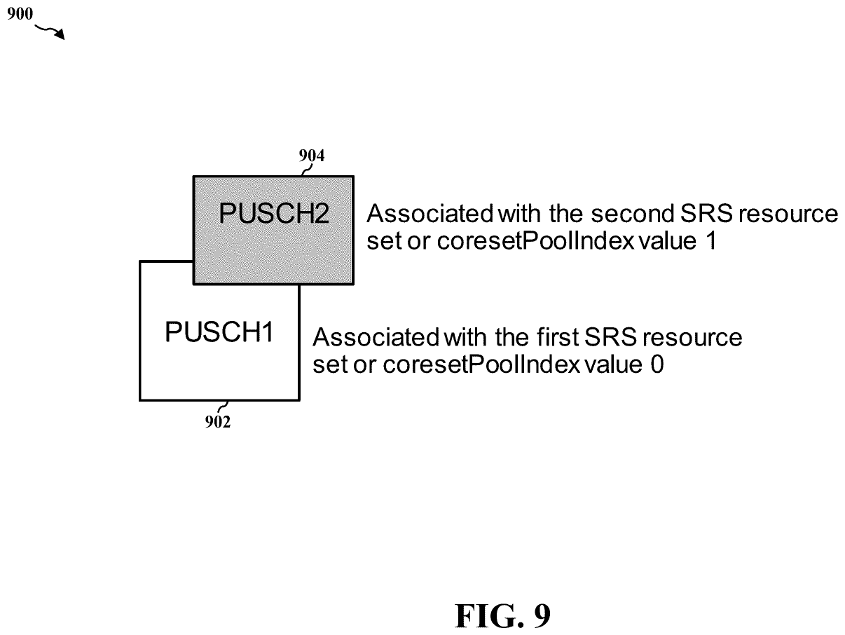

In instances of PUSCHs overlapping in the time domain, as shown for example in diagram 900 of FIG. 9, two different PUSCHs (e.g., PUSCH1 902, PUSCH2 904) in the same serving cell or CC may be partially or fully overlapping in at least the time domain. The PUSCH1 902 and PUSCH2 904 may or may not overlap in the frequency domain. This may be enabled by multi-DCI based mTRP framework, where the two PUSCHs may be associated with different coresetPoolIndex values, which may be distinct than SDM/FDM PUSCH with single DCI based framework, where simultaneous transmission is within a single PUSCH. In some instances, the PUSCH1 902 may be associated with a coresetPoolIndex value of 0 and may be associated with the first SRS resource set, such that the PUSCH1 902 is transmitted using a first beam, a first TCI state, first power control parameters, or a first precoder. The PUSCH2 904 may be associated with a corsetPoolIndex value of 1 and may be associated with the second SRS resource set, such that the PUSCH2 904 is transmitted using a second beam, a second TCI state, second power control parameters, or a second precoder.

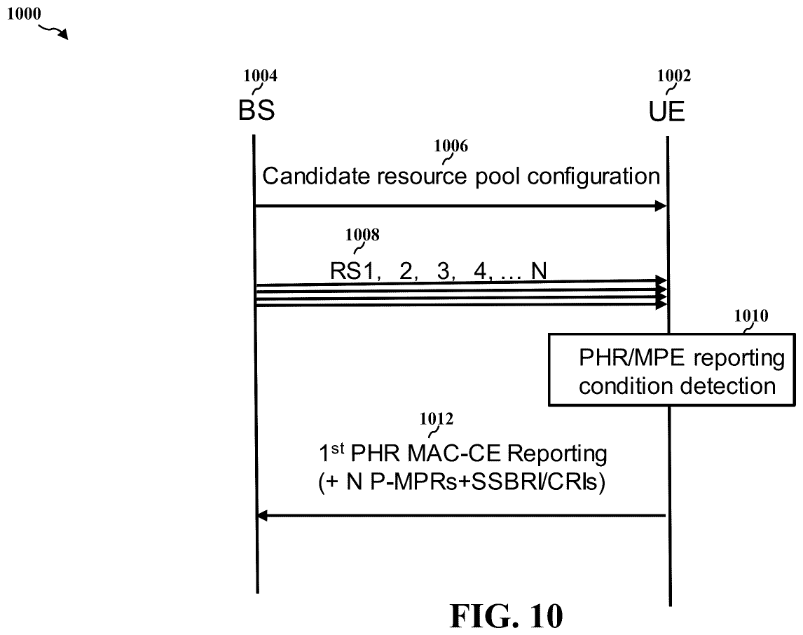

FIG. 10 illustrates an example diagram 1000 of an enhanced maximum permissible emission (MPE) MAC-CE between a UE 1002 and a base station 1004. The base station 1004 may provide the UE 1002 with a candidate resource pool configuration 1006. The base station 1004 may transmit one or more reference signals 1008 to the UE. The UE 1002 may determine whether a PHR/MPE reporting condition 1010 has been detected. The enhanced MPE MAC-CE may be triggered when a P-MPR of a current uplink beam exceeds a threshold. The UE 1002 may transmit a first PHR MAC-CE 1012. The first PHR MAC-CE 1012 may report N P-MPR values associated with N uplink beams. For each of the N P-MPR values, the UE may also report a corresponding SSBRI/CRI selected from a RRC configured candidate SSB/CSI-RS resource pool. In some aspects, the UE may support N=1, 2, 3, or 4. A largest N value supported by the UE may be based on a UE capability. An RRC configured resource pool (e.g., mpe-ResourcePool-r17) may comprise a list of up to 64 SSBs or CSI-RS resources out of which the UE reports up to N SSBs or CSI-RS resources.

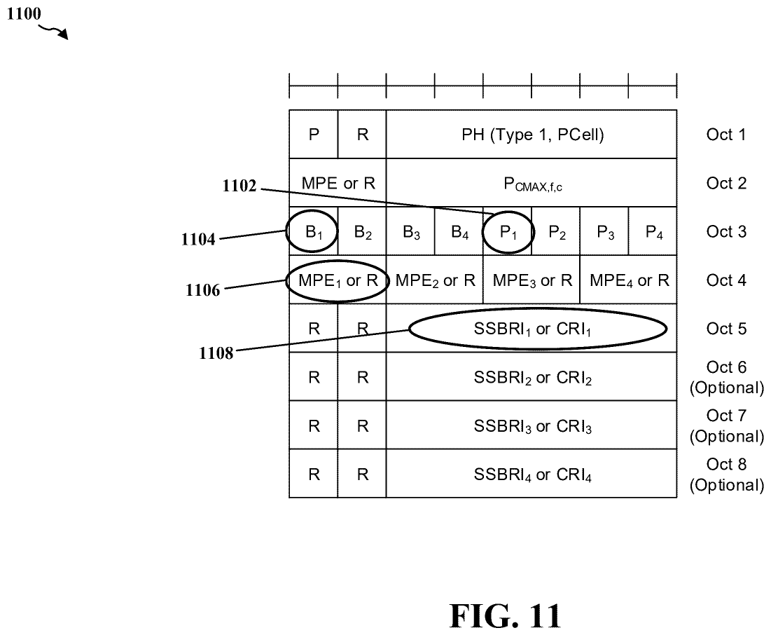

FIG. 11 illustrates an example diagram 1100 of an enhanced MPE report. Field 1104 may indicate whether a candidate beam information identified by either SSBRIᵢ or CRIᵢ is present or not. Field 1106 may indicate the applied power backoff to meet MPE requirements (e.g., if Pᵢ is set to 1). Field 1102 may be set to 0 in instances where the applied P-MPR value is less than a threshold. Field 1108 indicates the first SSB or CSI-RS associated with an uplink beam for which the MPE is reported within the enhanced MPE report. The MPE configuration (e.g., MPE-Config-FR2-r17) may comprise an integer value between 1-4 for a number of N resources (e.g., numberOfN-r17), as well as a resource pool (e.g., mpe-ResourcePool-r17) that may be based on a size of maximum MPE resources (e.g., maxMPE-Resources-r17, MPE-Resource-r17).

In instances of simultaneous PUSCH transmissions, such as SDM/FDM PUSCH for single-DCI, two fully or partially PUSCHs overlapping in the time domain for multi-DCI, the UE may use two panels in frequency range 2 (FR2). The MPE value may be different on different panels. The MPE resource pool may be separately configured for separates MPE reports associated with different UE panels. A UE capability for a maximum number of reported MPE values or SSBRIs/CRIs may be on a per panel basis or across both panels.

In instances of multi-DCI based mTRP, where a UE is configured with two coresetPoolIndex values, the UE may be configured with separate or joint PHR triggering and reporting. Separate PHR triggering and reporting may be more suitable for non-ideal backhaul between TRPs while joint PHR triggering and reporting may be more suitable in instances of good backhaul between TRPs.

Aspects presented herein provide a configuration for the reporting of PHR for simultaneous transmission. The aspects presented herein may allow a UE to report a PHR associated with a first resource pool or a second resource pool. In some aspects, the UE may be configured to report the PHR comprising an SSBRI or CRI associated with the first resource pool or an SSBRI or CRI associated with the second resource pool. In some aspects, the UE may be configured to report the PHR associated with the first resource pool or the second resource pool separately or jointly.

A UE may be configured with simultaneous transmissions in one CC may be configured with two separate MPE resource pools, were each resource pool corresponds to an SRS resource set, coresetPoolIndex value, UE panel identifier (ID), TRP identifier. Each resource pool may be configured with a list of SSB indices or CSI-RS resource IDs. In some instances, a maximum number of resources per resource pool that may be supported by the UE may be indicated within a UE capability. In some instances, a PHR may comprise N1 SSBRIs or CRIs and corresponding MPE values from the first MPE resource pool, and N2 SSBRIs or CRIs and corresponding MPE values from the second MPE resource pool. A field in the PHR MAC-CE may indicate whether a reported SSBRI or CRI, and corresponding MPE value, may be associated with the first resource pool or the second resource pool. The UE capability may be configured to indicate a maximum value of supported N1, N2, or N1+N2. For example, the UE may be configured to support the maximum number of N1 and the maximum number of N2. In some aspects, the UE may be configured to support the maximum number of N1+N2. The UE may indicate that the UE may support the maximum number of N1, the maximum number of N2, or both the maximum number of N1 and the maximum number of N2. The UE may indicate which of the at least one of N1, N2, or N1+N2 is supported in a UE capability report to the base station. The value of N1 or N2 may be configured via RRC signaling to the UE from the base station. In some instances, N1=N2=N, such that the UE may report N pairs of SSBRI/CRI and N corresponding pairs of MPE value. This may serve as an indication that UE may transmit two uplink beams corresponding to the pair simultaneously. This may be indicated based on these two are reported as a pair or are associated with each other. A first SSB/CSI-RS resource of each pair may be selected from the first resource pool and may be associated with at least one of the first SRS resource set, coresetPoolIndex value, a UE panel ID, a TRP ID, or the second SSB/CSI-RS resource of the pair selected from the second resource pool and associated with at least one of the second SRS resource set, coresetPoolIndex value, a UE panel ID, or a TRP ID.

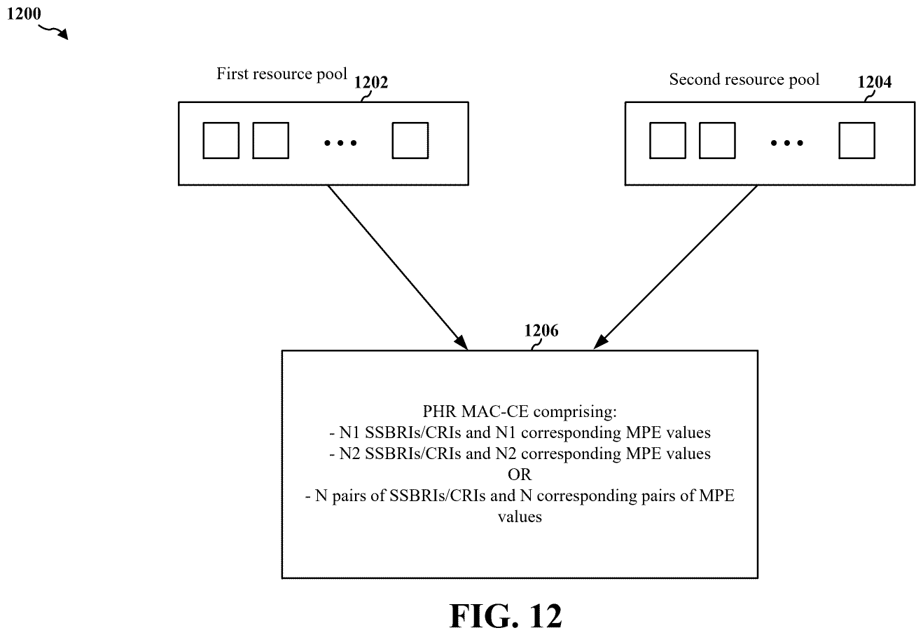

FIG. 12 illustrates an example diagram 1200 of a UE configured with two separate resource pools. For example, the UE may be configured with a first resource pool 1202 and a second resource pool 1204. For the first resource pool 1202, the UE may select N1 SSBs/CSI-RS resources, such that the UE may report MPE values associated with the corresponding uplink beams. For the second resource pool 1204, the UE may select N2 SSBs/CSI-RS resources, such that the UE may report MPE values associated with the corresponding uplink beams. The UE may transmit a PHR MAC-CE 1206. The PHR MAC-CE may comprise N1 SSBRIs/CRIs and N1 corresponding MPE values, N2 SSBRIs/CRIs and N2 corresponding MPE values, or N pairs of SSBRIs/CRIs and N corresponding pairs of MPE values. In some instances, such as instances of uplink carrier aggregation and multiple entry PHR, the MAC-CE may include the information of the PHR MAC-CE on a per CC basis. For example, the MAC-CE (e.g., 1206) may comprise N1 SSBRIs/CRIs and N1 corresponding MPE values, N2 SSBRIs/CRIs and N2 corresponding MPE values, or N pairs of SSBRIs/CRIs and N corresponding pairs of MPE values for each of the CCs, such that the information for each of the CCs may be concatenated as one MAC-CE.

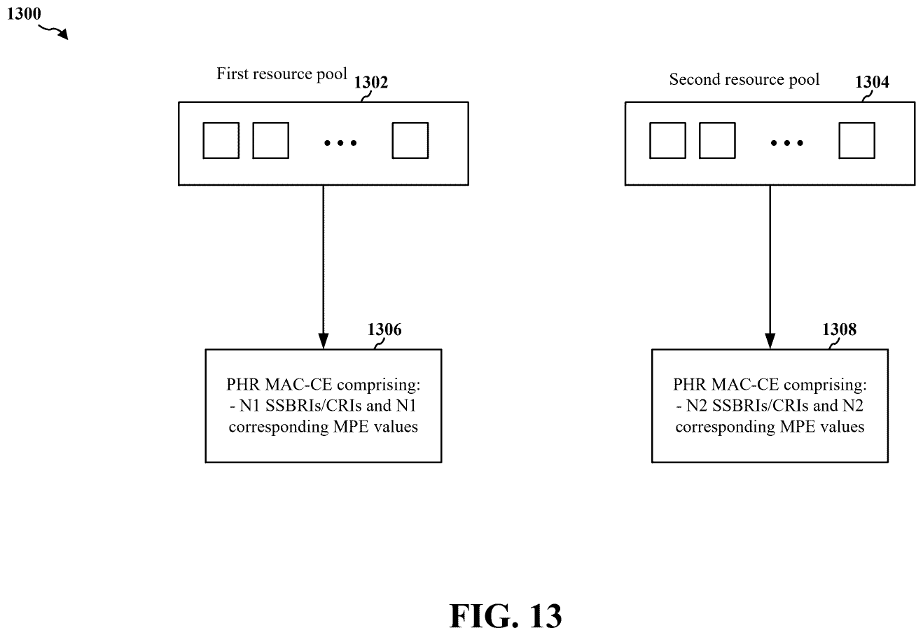

In instances of multi-DCI based mTRP, such that the UE is configured with two coresetPoolIndex values, and if the UE is configured with separate PHR triggering and reporting (e.g., PHR MAC-CE corresponds to one coresetPoolIndex value), then if the PHR MAC-CE is associated with a coresetPoolIndex value of 0, then the UE reports N1 SSBRIs/CRIs and corresponding MPE values associated with the first MPE resource pool. If the PHR MAC-CE is associated with a coresetPoolIndex value of 1, then the UE reports N2 SSBRIs/CRIs and corresponding MPE values associated with the second MPE resource pool. For example, with reference to diagram 1300 of FIG. 13, the UE may be configured with a first resource pool 1302 and a second resource pool 1304. The PHR MAC-CE 1306 may comprise N1 SSBRIs/CRIs and N1 corresponding MPE values. The PHR MAC-CE 1308 may comprise N2 SSBRIs/CRIs and N2 corresponding MPE values. The association of the PHR MAC-CE with the coresetPoolIndex value may be based on at least one of a field in the MAC-CE (e.g., indicated by the PHR MAC-CE) or based on the coresetPoolIndex value that the PUSCH carrying the MAC-CE is associated with.

In instances of multi-DCI based mTRP, such that the UE is configured with two coresetPoolIndex values, the UE may be configured with either separate or joint PHR triggering and reporting. The UE may be configured with separate or joint PHR triggering and reporting via RRC signaling. In instances where the UE is configured with separate PHR triggering and reporting, the UE may be configured with separate PHR configurations including separate timer values (e.g., periodic timer, prohibit timer). In some instances, one PHR configuration may be associated with one coresetPoolIndex value. In some instances, when the PHR is triggered for a coresetPoolIndex value, the PHR MAC-CE may comprise a PHR report for one or more CCs that are configured with that coresetPoolIndex value. In instances where the UE is configured with joint PHR triggering and reporting, when the PHR is triggered for a CC that is configured with 2 coresetPoolIndex values, the PHR MAC-CE may include two PHR reports, where one is associated with coresetPoolIndex value 0 and another is associated with coresetPoolIndex value 1.

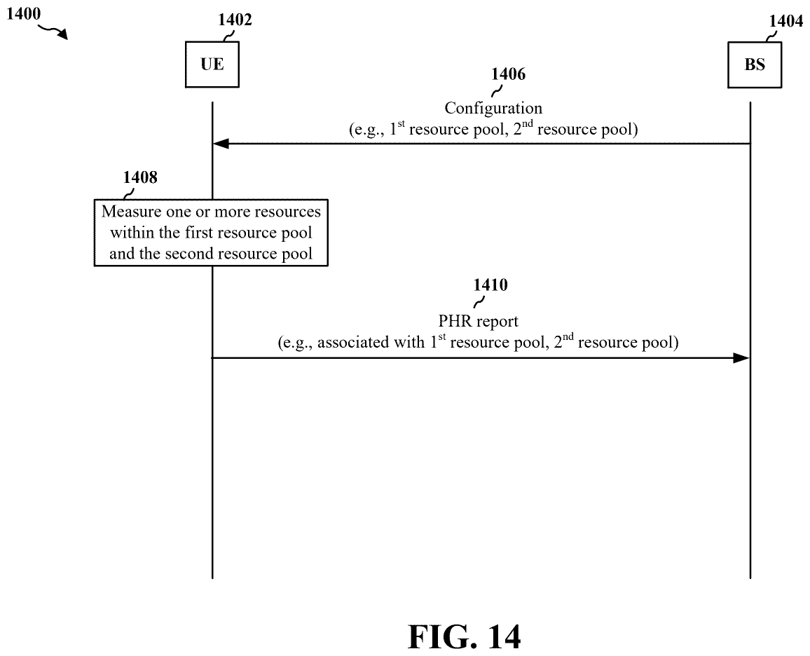

FIG. 14 is a call flow diagram 1400 of signaling between a UE 1402 and a base station 1404. The base station 1404 may be configured to provide at least one cell. The UE 1402 may be configured to communicate with the base station 1404. For example, in the context of FIG. 1, the base station 1404 may correspond to base station 102 and. Further, a UE 1402 may correspond to at least UE 104. In another example, in the context of FIG. 3, the base station 1404 may correspond to base station 310 and the UE 1402 may correspond to UE 350.

At 1406, the base station 1404 may provide a configuration to the UE 1402. The UE 1402 may receive the configuration from the base station 1404. In some aspects, the configuration may comprise a first resource pool and a second resource pool. Each of the first resource pool and the second resource pool may correspond to at least a respective SRS resource set. In some aspects, the configuration may configure the UE with separate or joint PHR triggering and reporting.

At 1408, the UE 1402 may measure one or more resources within the first resource pool and the second resource pool. The UE 1402 may measure the one or more resources within the first resource pool and the second resource pool based on the configuration received from the base station 1404.

At 1410, the UE 1402 may transmit a PHR to the base station 1404. The base station 1404 may receive the PHR from the UE 1402. The UE may transmit the PHR to the base station based on the measurement of the one or more resources within the first resource pool and the second resource pool.

In some aspects, the PHR may comprise at least one SSBRI or CRI. The at least one SSBRI or CRI may be associated with the first resource pool or at least one SSBRI or CRI associated with the second resource pool. In some aspects, the PHR may further comprise first MPE values corresponding to the at least one SSBRI or CRI from the first resource pool and second MPE values corresponding to the at least one SSBRI or CRI from the second resource pool. The PHR may indicate that the at least one SSBRI or CRI are associated with the first resource pool or the second resource pool. The PHR may comprise N1 SSBRIs or CRIs and the first MPE values from the first resource pool and N2 SSBRIs or CRIs and the second MPE values from the second resource pool, where N1 and N2 are the maximum number of resources per resource pool supported by the UE. In some aspects, the UE may be configured to support at least one of N1, N2, or N1+N2. For example, the UE may be configured to support the maximum number of N1 and the maximum number of N2. In some aspects, the UE may be configured to support the maximum number of N1+N2. The UE may indicate that the UE may support the maximum number of N1, the maximum number of N2, or both the maximum number of N1 and the maximum number of N2. The UE may indicate which of the at least one of N1, N2, or N1+N2 is supported in a UE capability report to the base station. In some aspects, a value of each of N1 and N2 may be configured via radio resource control (RRC) signaling. In some aspects, for example in instances where N1=N2, the PHR may comprise N pairs of SSBRIs or CRIs and N corresponding pairs of MPE values. In such instances, two uplink beams corresponding to the N pairs may be configured to be transmitted simultaneously. In some aspects, a first SSB/CSI-RS resource of each of the N pairs may be selected from the first resource pool and may be associated with at least a first SRS resource set of the first resource pool. In some aspects, a second SSB/CSI-RS resource of each of the N pairs may be selected from the second resource pool and may be associated with at least a second SRS resource set of the second resource pool. In some aspects, the PHR may comprise first MPE values corresponding to the at least one SSBRI or CRI from the first resource pool or second MPE values corresponding to the at least one SSBRI or CRI from the second resource pool based on a value of a resource pool index. The value of the resource pool index may be indicated via MAC-CE or may be based on a PUSCH carrying the MAC-CE.

In some aspects, the PHR may be associated with the first resource pool or the second resource pool separately or jointly based on the configuration. In some aspects, the configuration may configure transmission of the PHR as separate transmissions. In such instances, the UE may be configured with separate PHR configurations, such that the separate PHR configurations are associated with a respective value. The configuration may configure separate PHR triggering at the UE. In such instances, a PHR may be triggered based on the respective value. The PHR may be associated with one or more component carriers (CCs) that are associated with the respective value. In some aspects, the configuration may configure transmission of the PHR as joint triggering and reporting. In such aspects, a PHR may be triggered based on a CC that is configured within two resource pool values. In some aspects, the PHR may comprise two PHRs, where a first PHR may be associated with a first resource pool value, and a second PHR may be associated with a second resource pool value.

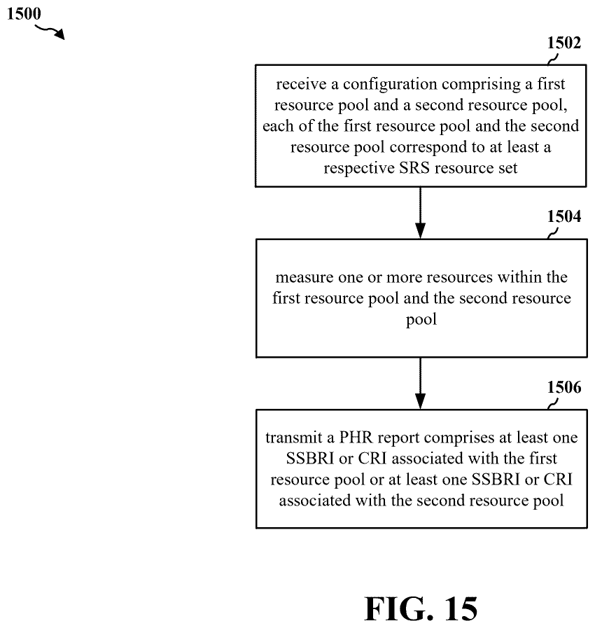

FIG. 15 is a flowchart 1500 of a method of wireless communication. The method may be performed by a UE (e.g., the UE 104; the apparatus 1704). One or more of the illustrated operations may be omitted, transposed, or contemporaneous. The method may allow a UE to report a PHR comprising an SSBRI or CRI associated with the first resource pool or an SSBRI or CRI associated with the second resource pool.

At 1502, the UE may receive a configuration comprising a first resource pool and a second resource pool. For example, 1502 may be performed by PHR component 198 of apparatus 1704. The UE may receive the configuration from a base station. Each of the first resource pool and the second resource pool may correspond to at least a respective SRS resource set.

At 1504, the UE may measure one or more resources within the first resource pool and the second resource pool. For example, 1504 may be performed by PHR component 198 of apparatus 1704.

At 1506, the UE may transmit a PHR. For example, 1506 may be performed by PHR component 198 of apparatus 1704. The UE may transmit the PHR to the base station. The UE may transmit the PHR to the base station based on the measurement of the one or more resources within the first resource pool and the second resource pool. The PHR may comprise at least one SSBRI or CRI. The at least one SSBRI or CRI may be associated with the first resource pool or at least one SSBRI or CRI associated with the second resource pool. In some aspects, the PHR may further comprise first MPE values corresponding to the at least one SSBRI or CRI from the first resource pool and second MPE values corresponding to the at least one SSBRI or CRI from the second resource pool. The PHR may indicate that the at least one SSBRI or CRI are associated with the first resource pool or the second resource pool. The PHR may comprise N1 SSBRIs or CRIs and the first MPE values from the first resource pool and N2 SSBRIs or CRIs and the second MPE values from the second resource pool, where N1 and N2 are the maximum number of resources per resource pool supported by the UE. In some aspects, the UE may be configured to support at least one of N1, N2, or N1+N2. For example, the UE may be configured to support the maximum number of N1 and the maximum number of N2. In some aspects, the UE may be configured to support the maximum number of N1+N2. The UE may indicate that the UE may support the maximum number of N1, the maximum number of N2, or both the maximum number of N1 and the maximum number of N2. The UE may indicate which of the at least one of N1, N2, or N1+N2 is supported in a UE capability report to the base station. In some aspects, a value of each of N1 and N2 may be configured via radio resource control (RRC) signaling. In some aspects, for example in instances where N1=N2, the PHR may comprise N pairs of SSBRIs or CRIs and N corresponding pairs of MPE values. In such instances, two uplink beams corresponding to the N pairs may be configured to be transmitted simultaneously. In some aspects, a first SSB/CSI-RS resource of each of the N pairs may be selected from the first resource pool and may be associated with at least a first SRS resource set of the first resource pool. In some aspects, a second SSB/CSI-RS resource of each of the N pairs may be selected from the second resource pool and may be associated with at least a second SRS resource set of the second resource pool. In some aspects, the PHR may comprise first MPE values corresponding to the at least one SSBRI or CRI from the first resource pool or second MPE values corresponding to the at least one SSBRI or CRI from the second resource pool based on a value of a resource pool index. The value of the resource pool index may be indicated via MAC-CE or may be based on a PUSCH carrying the MAC-CE.

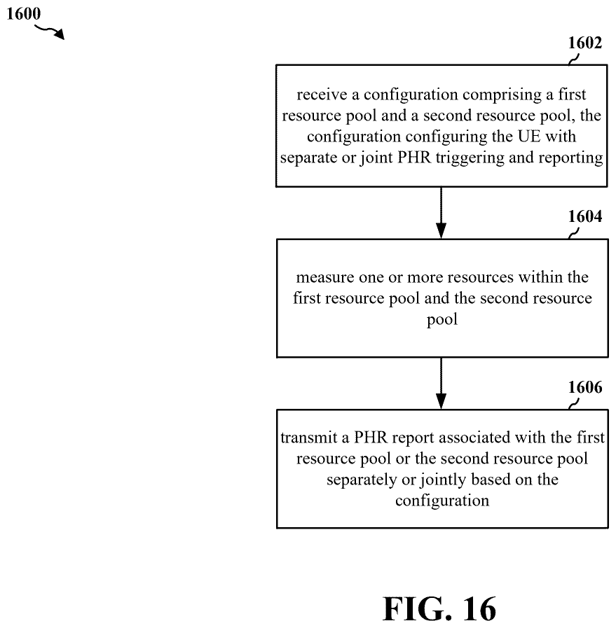

FIG. 16 is a flowchart 1600 of a method of wireless communication. The method may be performed by a UE (e.g., the UE 104; the apparatus 1704). One or more of the illustrated operations may be omitted, transposed, or contemporaneous. The method may allow a UE to report a PHR associated with a first resource pool or a second resource pool separately or jointly.

At 1602, the UE may receive a configuration comprising a first resource pool and a second resource pool. For example, 1602 may be performed by PHR component 198 of apparatus 1704. The UE may receive the configuration from a base station. The configuration may configure the UE with separate or joint PHR triggering and reporting.

At 1604, the UE may measure one or more resources within the first resource pool and the second resource pool. For example, 1604 may be performed by PHR component 198 of apparatus 1704.

At 1606, the UE may transmit a PHR. For example, 1606 may be performed by PHR component 198 of apparatus 1704. The UE may transmit the PHR to the base station. The UE may transmit the PHR to the base station based on the measurement of the one or more resources within the first resource pool and the second resource pool. The PHR may be associated with the first resource pool or the second resource pool separately or jointly based on the configuration. In some aspects, the configuration may configure transmission of the PHR as separate transmissions. In such instances, the UE may be configured with separate PHR configurations, such that the separate PHR configurations are associated with a respective value. The configuration may configure separate PHR triggering at the UE. In such instances, a PHR may be triggered based on the respective value. The PHR may be associated with one or more CCs that are associated with the respective value. In some aspects, the configuration may configure transmission of the PHR as joint triggering and reporting. In such aspects, a PHR may be triggered based on a CC that is configured within two resource pool values. In some aspects, the PHR may comprise two PHRs, where a first PHR may be associated with a first resource pool value, and a second PHR may be associated with a second resource pool value.

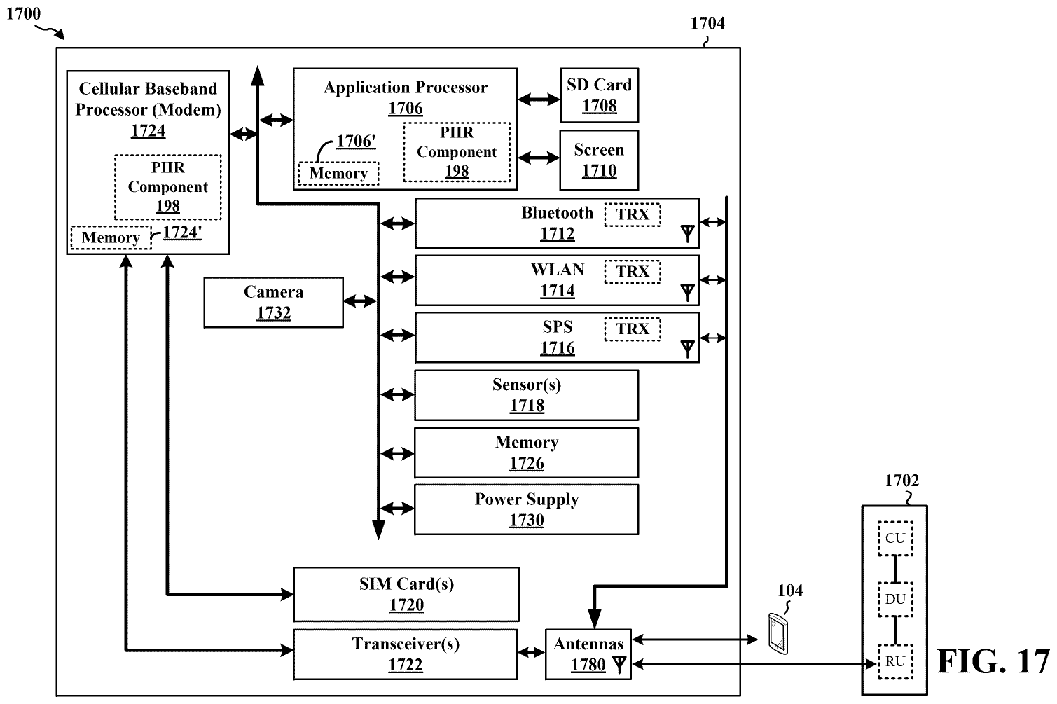

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the component 198 is configured to receive a configuration comprising a first resource pool and a second resource pool, each of the first resource pool and the second resource pool correspond to at least a respective SRS resource set; measure one or more resources within the first resource pool and the second resource pool; and transmit a PHR comprises at least one SSBRI or CRI associated with the first resource pool or at least one SSBRI or CRI associated with the second resource pool. The component 198 is configured to receive a configuration comprising a first resource pool and a second resource pool, the configuration configuring the UE with separate or joint PHR triggering and reporting; measure one or more resources within the first resource pool and the second resource pool; and transmit a PHR associated with the first resource pool or the second resource pool separately or jointly based on the configuration. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for receiving a configuration comprising a first resource pool and a second resource pool, each of the first resource pool and the second resource pool correspond to at least a respective SRS resource set. The apparatus includes means for measuring one or more resources within the first resource pool and the second resource pool. The apparatus includes means for transmitting a PHR comprises at least one SSBRI or CRI associated with the first resource pool or at least one SSBRI or CRI associated with the second resource pool. The apparatus includes means for receiving a configuration comprising a first resource pool and a second resource pool, the configuration configuring the UE with separate or joint PHR triggering and reporting. The apparatus includes means for measuring one or more resources within the first resource pool and the second resource pool. The apparatus includes means for transmitting a PHR associated with the first resource pool or the second resource pool separately or jointly based on the configuration. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising receiving a configuration comprising a first resource pool and a second resource pool, each of the first resource pool and the second resource pool correspond to at least a respective SRS resource set; measuring one or more resources within the first resource pool and the second resource pool; and transmitting a PHR comprises at least one SSBRI or CRI associated with the first resource pool or at least one SSBRI or CRI associated with the second resource pool.

Aspect 2 is the method of aspect 1, further includes that the PHR further comprises first MPE values corresponding to the at least one SSBRI or CRI from the first resource pool and second MPE values corresponding to the at least one SSBRI or CRI from the second resource pool.

Aspect 3 is the method of any of aspects 1 and 2, further includes that the PHR indicates that the at least one SSBRI or CRI are associated with the first resource pool or the second resource pool.

Aspect 4 is the method of any of aspects 1-3, further includes that the PHR comprises N1 SSBRIs or CRIs and the first MPE values from the first resource pool and N2 SSBRIs or CRIs and the second MPE values from the second resource pool.

Aspect 5 is the method of any of aspects 1-4, further includes that the UE is configured to support at least one of N1, N2, or N1+N2.

Aspect 6 is the method of any of aspects 1-5, further includes that a value of each of N1 and N2 is configured via RRC signaling.

Aspect 7 is the method of any of aspects 1-6, further includes that the PHR comprises N pairs of SSBRIs or CRIs and N corresponding pairs of MPE values in response to N1=N2.

Aspect 8 is the method of any of aspects 1-7, further includes that two uplink beams corresponding to the N pairs are configured to be transmitted simultaneously.

Aspect 9 is the method of any of aspects 1-8, further includes that a first SSB/CSI-RS resource of each of the N pairs is selected from the first resource pool and is associated with at least a first SRS resource set of the first resource pool.

Aspect 10 is the method of any of aspects 1-9, further includes that a second SSB/CSI-RS resource of each of the N pairs is selected from the second resource pool and is associated with at least a second SRS resource set of the second resource pool.

Aspect 11 is the method of any of aspects 1-10, further includes that the PHR comprises first MPE values corresponding to the at least one SSBRI or CRI from the first resource pool or second MPE values corresponding to the at least one SSBRI or CRI from the second resource pool based on a value of a resource pool index.

Aspect 12 is the method of any of aspects 1-11, further includes that the value of the resource pool index is indicated by a MAC-CE or based on a PUSCH carrying the MAC-CE.

Aspect 13 is an apparatus for wireless communication at a UE including at least one processor coupled to a memory and at least one transceiver, the at least one processor configured to implement any of Aspects 1-12.

Aspect 14 is an apparatus for wireless communication at a UE including means for implementing any of Aspects 1-12.

Aspect 15 is a computer-readable medium storing computer executable code, where the code when executed by a processor causes the processor to implement any of Aspects 1-12.

Aspect 16 is a method of wireless communication at a UE comprising receiving a configuration comprising a first resource pool and a second resource pool, the configuration configuring the UE with separate or joint PHR triggering and reporting; measuring one or more resources within the first resource pool and the second resource pool; and transmitting a PHR associated with the first resource pool or the second resource pool separately or jointly based on the configuration.

Aspect 17 is the method of aspect 16, further includes that the configuration configures transmission of the PHR as separate transmissions, wherein the UE is configured with separate PHR configurations, wherein the separate PHR configurations are associated with a respective value.

Aspect 18 is the method of any of aspects 16 and 17, further includes that the configuration configures separate PHR triggering.

Aspect 19 is the method of any of aspects 16-18, further includes that a PHR is triggered based on the respective value, wherein the PHR is associated with one or more CCs that are associated with the respective value.

Aspect 20 is the method of any of aspects 16-19, further includes that the configuration configures transmission of the PHR as joint triggering and reporting, wherein a PHR is triggered based on a CC that is configured with 2 resource pool values.

Aspect 21 is the method of any of aspects 16-20, further includes that the PHR comprises two PHRs, wherein a first PHR is associated with a first resource pool value, and a second PHR is associated with a second resource pool value.

Aspect 22 is an apparatus for wireless communication at a UE including at least one processor coupled to a memory and at least one transceiver, the at least one processor configured to implement any of Aspects 16-21.

Aspect 23 is an apparatus for wireless communication at a UE including means for implementing any of Aspects 16-21.

Aspect 24 is a computer-readable medium storing computer executable code, where the code when executed by a processor causes the processor to implement any of Aspects 16-21.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration comprising a first resource pool and a second resource pool, each of the first resource pool and the second resource pool correspond to at least a respective sounding reference signal (SRS) resource set;
measure one or more resources within the first resource pool and the second resource pool; and
transmit a power headroom report (PHR) comprises at least one synchronization signal block (SSB) resource indicator (SSBRI) or channel state indicator reference signal (CSI-RS) resource indicator (CRI) associated with the first resource pool or at least one SSBRI or CRI associated with the second resource pool.

2. The apparatus of claim 1, further comprising a transceiver coupled to the at least one processor.

3. The apparatus of claim 1, wherein the PHR further comprises first maximum permissible emission (MPE) values corresponding to the at least one SSBRI or CRI from the first resource pool and second MPE values corresponding to the at least one SSBRI or CRI from the second resource pool.

4. The apparatus of claim 3, wherein the PHR indicates that the at least one SSBRI or CRI are associated with the first resource pool or the second resource pool.

5. The apparatus of claim 3, wherein the PHR comprises N1 SSBRIs or CRIs and the first MPE values from the first resource pool and N2 SSBRIs or CRIs and the second MPE values from the second resource pool.

6. The apparatus of claim 5, wherein the UE is configured to support at least one of N1, N2, or N1+N2.

7. The apparatus of claim 5, wherein a value of each of N1 and N2 is configured via radio resource control (RRC) signaling.

8. The apparatus of claim 5, wherein the PHR comprises N pairs of SSBRIs or CRIs and N corresponding pairs of MPE values in response to N1=N2.

9. The apparatus of claim 8, wherein two uplink beams corresponding to the N pairs are configured to be transmitted simultaneously.

10. The apparatus of claim 8, wherein a first SSB/CSI-RS resource of each of the N pairs is selected from the first resource pool and is associated with at least a first SRS resource set of the first resource pool.

11. The apparatus of claim 8, wherein a second SSB/CSI-RS resource of each of the N pairs is selected from the second resource pool and is associated with at least a second SRS resource set of the second resource pool.

12. The apparatus of claim 1, wherein the PHR comprises first maximum permissible emission (MPE) values corresponding to the at least one SSBRI or CRI from the first resource pool or second MPE values corresponding to the at least one SSBRI or CRI from the second resource pool based on a value of a resource pool index.

13. The apparatus of claim 12, wherein the value of the resource pool index is indicated by a media access control (MAC) control element (CE) (MAC-CE) or based on a physical uplink shared channel (PUSCH) carrying the MAC-CE.

14. A method of wireless communication at a user equipment (UE), comprising:
receiving a configuration comprising a first resource pool and a second resource pool, each of the first resource pool and the second resource pool correspond to at least a respective sounding reference signal (SRS) resource set;
measuring one or more resources within the first resource pool and the second resource pool; and
transmitting a power headroom report (PHR) comprises at least one synchronization signal block (SSB) resource indicator (SSBRI) or channel state indicator reference signal (CSI-RS) resource indicator (CRI) associated with the first resource pool or at least one SSBRI or CRI associated with the second resource pool.

15. The method of claim 14, wherein the PHR further comprises first maximum permissible emission (MPE) values corresponding to the at least one SSBRI or CRI from the first resource pool and second MPE values corresponding to the at least one SSBRI or CRI from the second resource pool.

16. The method of claim 15, wherein the PHR indicates that the at least one SSBRI or CRI are associated with the first resource pool or the second resource pool.

17. The method of claim 14, wherein the PHR comprises first maximum permissible emission (MPE) values corresponding to the at least one SSBRI or CRI from the first resource pool or second MPE values corresponding to the at least one SSBRI or CRI from the second resource pool based on a value of a resource pool index.

18. The method of claim 17, wherein the value of the resource pool index is indicated by a media access control (MAC) control element (CE) (MAC-CE) or based on a physical uplink shared channel (PUSCH) carrying the MAC-CE.

19. An apparatus for wireless communication at a user equipment (UE), comprising:
a memory; and
at least one processor coupled to the memory and, based at least in part on information stored in the memory, the at least one processor is configured to:
receive a configuration comprising a first resource pool and a second resource pool, the configuration configuring the UE with separate or joint power headroom report (PHR) triggering and reporting;
measure one or more resources within the first resource pool and the second resource pool; and
transmit a PHR associated with the first resource pool or the second resource pool separately or jointly based on the configuration.

20. The apparatus of claim 19, further comprising a transceiver coupled to the at least one processor.

21. The apparatus of claim 19, wherein the configuration configures transmission of the PHR as separate transmissions, wherein the UE is configured with separate PHR configurations, wherein the separate PHR configurations are associated with a respective value.

22. The apparatus of claim 21, wherein the configuration configures separate PHR triggering.

23. The apparatus of claim 22, wherein a PHR is triggered based on the respective value, wherein the PHR is associated with one or more component carriers (CCs) that are associated with the respective value.

24. The apparatus of claim 19, wherein the configuration configures transmission of the PHR as joint triggering and reporting, wherein a PHR is triggered based on a component carrier (CC) that is configured with 2 resource pool values.

25. The apparatus of claim 24, wherein the PHR comprises two PHRs, wherein a first PHR is associated with a first resource pool value, and a second PHR is associated with a second resource pool value.

26. A method of wireless communication at a user equipment (UE), comprising:
receiving a configuration comprising a first resource pool and a second resource pool, the configuration configuring the UE with separate or joint power headroom report (PHR) triggering and reporting;
measuring one or more resources within the first resource pool and the second resource pool; and
transmitting a PHR associated with the first resource pool or the second resource pool separately or jointly based on the configuration.

27. The method of claim 26, wherein the configuration configures transmission of the PHR as separate transmissions, wherein the UE is configured with separate PHR configurations, wherein the separate PHR configurations are associated with a respective value.

28. The method of claim 27, wherein the configuration configures separate PHR triggering.

29. The method of claim 28, wherein a PHR is triggered based on the respective value, wherein the PHR is associated with one or more component carriers (CCs) that are associated with the respective value.

30. The method of claim 26, wherein the configuration configures transmission of the PHR as joint triggering and reporting, wherein a PHR is triggered based on a component carrier (CC) that is configured with 2 resource pool values, wherein the PHR comprises two PHRs, wherein a first PHR is associated with a first resource pool value, and a second PHR is associated with a second resource pool value.
